(19) United States
(12) Patent Application Publication
(10) Pub. No.: US 2005/0163891 A1
(43) Pub. Date: Jul. 28, 2005

(54) Kits comprising a permanent filing container and pet health or care materials

(75) Inventor: Jennifer Marie Clark, Hamilton, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/029,555

(22) Filed: Jan. 5, 2005

Related U.S. Application Data
(60) Provisional application No. 60/534,250, filed on Jan. 5, 2004.

(51) Int. Cl. C12C 1/027

(52) U.S. Cl. 426/106

(57) ABSTRACT

Disclosed herein are kits comprising a permanent filing container and pet health or care materials. The kits are particularly useful for new pet owners requiring information or other materials regarding their new pet. The kits may be distributed via a variety of means, including via a veterinarian or pet breeder.

### CROSS REFERENCE TO RELATED APPLICATION

This Application claims the benefit of U.S. Provisional Application No. 60/534,250 filed on Jan. 5, 2004.

### FIELD OF THE INVENTION

The present invention is directed to kits comprising a permanent filing container and pet health or care materials. The kits are particularly useful for new pet owners requiring information or other materials regarding their new pet. The kits may be distributed via a variety of means, including via a veterinarian or pet breeder.

### BACKGROUND OF THE INVENTION

Pet owners have a responsibility to their pets to provide adequate care for their pets, including nutritional and other health care. Many pet owners will have the requisite experience or other basis of knowledge to care for a pet, however, other pet owners need various information regarding such requirements as nutrition, feeding, training, grooming, and the like. Still further, even wherein a pet owner does have the basis of knowledge to care for the pet, new information made available regarding new services or further care information should be readily available to the owner.

Previously, pet food or medicinal manufacturers or suppliers have provided kits to new pet owners to encourage purchase of certain products available from these entities. For example, kits containing samples of pet foods or medicinals, either alone or in combination with other components, such as information, have been available. However, these kits are not amenable for permanent storage or ease of use, such that when a pet owner needs to refer again to such information it may have been, unfortunately, been discarded. Still further, other kits may be inconvenient for use, or may not be readily used or referenced, due to the inability of the user to readily know the contents of the kit or where to access specific information or other materials within the kit. As a result, pet owners will often not have ready access to important care information, as it may be lost or discarded, or may become frustrated with the inadequate design of the overall kit.

There is therefore a need to provide kits directed to the health or other care of pets which is convenient to use and amenable for long term storage such that the kit may be readily accessed as needed. The present inventors have created such a kit, and provide such a kit herein.

### SUMMARY OF THE INVENTION

The present invention is directed to kits comprising:
(a) a permanent filing container comprising a first outer panel, a second outer panel, and a receptacle formed at least in part by the outer panels; and
(b) two or more components contained within the kit, wherein the components are selected from the group consisting of pet food; a pet medicinal; incentive material; pet care material; nutritional material; health record; insurance material; and contact material; wherein the at least a portion of an outer panel is substantially transparent such that at least two of the components may be at least be partially viewed through the transparency formed therefrom.

The kits are useful for conveniently providing to a user information or materials related to the health or care of a pet. In a preferred embodiment, the pet is a domestic dog or cat, even more preferably a domestic puppy or kitten.

### BRIEF DESCRIPTION OF THE FIGURES

FIG. 1 depicts a kit in accordance with the present invention. First outer panel 1 is depicted, as well as second outer panel 2.

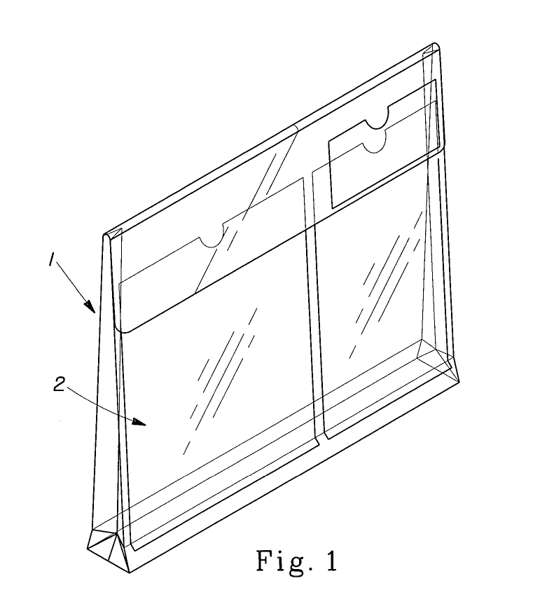

FIG. 2 depicts a kit in accordance with the present invention. Receptacle 3 is depicted.

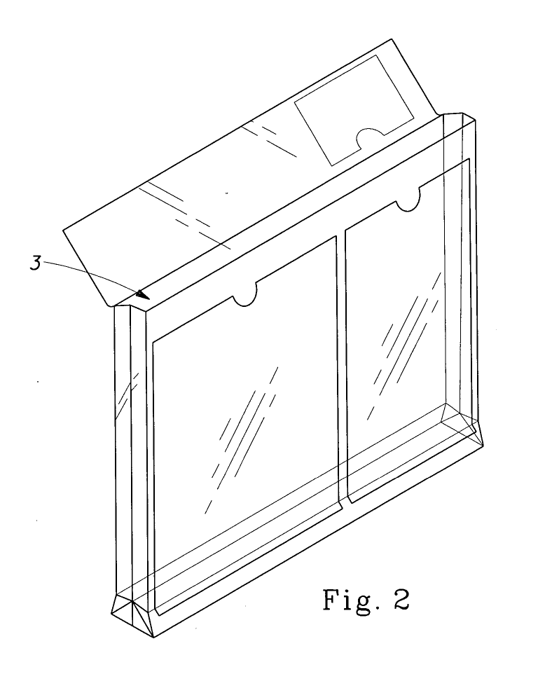

As deemed unnecessary, the figures do not depict the components contained within the kit.

### DETAILED DESCRIPTION OF THE INVENTION

The present invention is directed to kits comprising a permanent filing container and pet health or care materials. The kits are particularly useful for new pet owners requiring information or other materials regarding their new pet. The kits may be distributed via a variety of means, for example via a veterinarian or pet breeder to new pet owners.

Various documents including, for example, publications and patents, are recited throughout this disclosure. All such documents are hereby incorporated by reference.

In the description of the invention various embodiments and/or individual components are disclosed. As will be apparent to the ordinarily skilled practitioner, all combinations of such embodiments and components are possible and can result in preferred executions of the present invention.

The compositions herein may comprise, consist essentially of, or consist of any of the components as described herein.

While various embodiments and individual components of the present invention have been illustrated and described, various other changes and modifications can be made without departing from the spirit and scope of the invention. As will be also be apparent, all combinations of the embodiments and components taught in the foregoing disclosure are possible and can result in preferred executions of the invention.

As used herein, reference to a given animal include reference to such animal at all ages. For example, as used herein, the term “cat” includes cats of all ages, including kittens. As another example, as used herein, the term “dog” includes dogs of all ages, including puppies.

As used herein, the term “pet” refers to a domestic animal, such as a dog, cat, horse, cow, pig, ferret, rabbit, or the like. Preferably, the pet is a dog or cat. Most preferably, the pet is a puppy or kitten.

The Permanent Filing Container

The kits comprise a permanent filing container comprising a first outer panel, a second outer panel, and a receptacle formed at least in part by the outer panels. Various filing containers having this basic configuration are known in the art, for example, those described in U.S. Pat. Nos. 4,274,577; 4,830,268; 4,971,361; and 5,711,750.

A first outer panel and second outer panel are illustrated in FIGS. and 1 and 2, respectively.

At least a portion of one of the outer panels is substantially transparent such that at least two of the components, described in further detail herein below, may each be at least be partially viewed through the transparency formed therefrom. In one embodiment herein, at least a portion of each of the first outer panel and the second outer panel is substantially transparent. As used herein, the term “substantially transparent,” means that light is transmitted through the referenced portion such that a component may be at least partially viewed by the eye.

In one embodiment, the permanent filing container comprises means for connecting the first outer panel and the second outer panel. For example, the container may comprise a connecting panel which releasably or permanently connects the outer panels. Alternatively or additionally, the permanent filing container may comprise a flap which releasably or permanently connects the outer panels. Preferably, the container comprises a connecting panel which permanently connects the outer panels. Also preferably the container comprises a further means for connecting the outer panels, such as a flap which is permanently attached to the first outer panel and, optionally (but preferably), releasably attached to the second outer panel.

As used herein, the term “permanent attachment” refers to the attachment of two surfaces or other materials in such a manner that these two materials remained physically joined during ordinary use.

Means for releasably attaching certain materials are well-known in the art. As used herein, the term “releasably attached,” or the like, refers to that property which provides for initial permanent attachment of one material or surface to another and subsequent detachment thereof. For example, the user of the permanent filing container may wish to release a closure of two materials or surfaces, such that components may be deposited within the receptacle, and replace or reposition the closure.

Non limiting examples of such means include hook and look systems (for example, VELCRO), for example wherein such systems are integrated into the permanent filing container, or adhesives such as pressure sensitive adhesives. The ordinarily skilled artisan will recognize that a variety of other attachment means not explicitly described herein may be utilized.

In one embodiment, the permanent filing container is expandable. Expansion of the permanent filing container is particularly useful wherein the kit is designed to contain a variety of materials, including products and information, or wherein the user of the kit wishes to add further materials to the kit over time. For example, this may be achieved through modification of the first outer panel or the second outer panel, or may alternatively or additionally achieved through, for example, a connecting panel. To illustrate, one or more folds may be incorporated into the first outer panel, second outer panel, or both, such that the fold causes the container to expand upon opening the fold. As another example, wherein the connecting panel permanently connects the outer panels, the connecting panel may be an accordian-pleated connecting panel (thus having at least one pleat, preferably a plurality of pleats).

As has been stated, the permanent filing container comprises the outer panels, which forms the receptacle. This receptacle is useful for placing various components (as described in further detail herein below), within the container.

In one embodiment, one or more further panels may be permanently or releasably attached to the first outer panel or the second outer panel, for example on the outside surface of such panel or on the surface facing the receptacle. For example, in a preferred embodiment, two separate panels are permanently attached to the second outer panel on the surface of the outer panel which faces the receptacle. This forms two further receptacles which may be designed in accordance with a desired dimension, such as to place reading materials (for example, pet care material and nutritional material), pet food, or the like. As another example, a third outer panel is permanently attached to the outer surface of the second outer panel such that contact material (such as a business card) may be placed within the receptacle formed therefrom. In such examples, at least a portion of these further panels may be substantially transparent such that the component placed within the receptacle formed therefrom may at least be partially viewed.

Components

The kits further comprise two or more components contained within the kit, wherein the components are selected from the group consisting of pet food; a pet medicinal; incentive material; a pet care information; nutritional information; a health record; insurance material; and contact information. As has been stated at least a portion of one of the outer panels is substantially transparent such that at least two of the components may be at least be partially viewed through the transparency formed therefrom.

In one embodiment, the kits comprise three or more components, or at least about four or more components, or at least five or more components. Alternatively or additionally, at least a portion of one of the outer panels is substantially transparent such that at least three or more components, or at least about four or more components, or at least five or more components may be at least partially viewed through the transparency formed therefrom.

The components are illustrated as follows:

Pet Food

The kits herein may optionally comprise pet food. As used herein, the pet food may be packaged or unpackaged, such that wherein the pet food is at least in part viewed through a substantial transparency either the food itself or the packaging containing the food is viewed through the substantial transparency. Pet foods, and packaging therefore, are widely known in the art and as used herein pet foods will include nutritionally balanced food (suitable for daily use) or supplements such as pet treats, chews, or the like. In one embodiment the pet food is in a dry form, for example, as a plurality of kibbles. In one embodiment the pet food is packaged pet food. In a preferred embodiment, the pet food is packaged and in dry form. Often the pet food will be provided in a limited amount (i.e., a sample), such as a weekly, daily or multiple-day supply of the food, however, the amount of pet food is not limited.

Pet Medicinal

The kits herein may optionally comprise a pet medicinal. As used herein, the pet medicinal may be packaged or unpackaged, such that wherein the pet medicinal is at least in part viewed through a substantial transparency either the medicinal itself or the packaging containing the medicinal is viewed through the substantial transparency. Pet medicinals, and packaging therefore, are widely known in the art and as used herein pet medicinals will include any therapy utilized to prevent, treat, mitigate, or cure a condition in a pet. Pet medicinals are often distributed through veterinary channels or via the internet on the advice of a veterinarian, however, such pet medicinals such as medicinals for the treatment of flea or tick, and the like, are widely accessible to consumers via the internet or retail channels such as grocery stores, pet supply stores, club stores, and the like. Often the pet medicinal will be provided in a limited amount (i.e., a sample), such as a weekly, daily or multiple-day supply of the medicinal, however, the amount of pet medicinal is not limited.

Incentive Material

The kits herein may optionally comprise incentive material. Incentive material is widely known in the art and will include such examples as coupons (such as for free or discounted products, preferably pet care products such as pet foods, pet medicinals, and the like) or other offers to provide free or discounted products, information, or other materials. Typically incentive material will encourage consumers to sample, purchase, or otherwise utilize a particular product, such as a particular brand of pet food, pet medicinal, or other pet care product. However, the incentive material need not be restricted to such material related to pet care, rather the incentive material may be directed to any product or information that may be of interest to a consumer also having interest in the kit. Examples may include co-promotional materials such as wherein a corporate supplier of the kit wishes to encourage the pet owner to sample, purchase, or otherwise utilize other products or information supplied by the supplier, or supplied by a partner of the supplier.

Pet Care Material

The kits herein may optionally provide pet care material. Pet care material will include information suitable for a pet owner and relating to general care of a pet. Examples include information relating to methods by which pets may be identified if lost, how to keep a home safe for a pet, training a pet, exercising a pet, introducing a pet to people (such as, children) or other animals, supplies necessary or desirable for care of a pet (for example, collars, leashes, and the like), grooming the pet, and the like.

Nutritional Material

The kits herein may optionally provide nutritional material. Nutritional material will include information suitable for a pet owner and relating to nutritional needs of a pet or nutritional benefits of pet food (including a specific pet food).

Health Record

The kits herein may optionally provide a health record. The health record is a record which enables the pet owner or other person (such as a veterinarian or breeder) to record information regarding the pet's health status, such as records of vaccination. For example, health records may include a listing of various recommended vaccinations together with areas of the record which allow the user to indicate time or frequency of vaccination. Using the dog as an example, examples of vaccinations which may be indicated on the health record may include one or more of distemper, infectious canine hepatitis, leptospirosis, parainfluenza, parvovirus infection, coronavirus, bordatella (kennel cough), lyme disease, or rabies. Additionally or alternatively, health records may include prompts regarding size, age, weight, fecal exams, heartworm tests, or the like, of the pet, such that the user may record these statistics at various times or frequencies.

Insurance Material

The kits herein may optionally provide insurance material. The insurance material is information relating to insurance for a pet, such as general information for educational purposes, sample policies or certain terms thereof, and the like. An insurance policy may be actually or constructively provided. By actually providing the insurance policy, a valid policy or policy which may be validated is presented within the kit. By constructively providing the insurance policy, an offer to immediately or later purchase the insurance policy, an application for an insurance policy, an offer to receive an application, or directions or other information regarding how to obtain the policy is presented within the kit. Insurance material is widely available in the art including, for example, information provided by Veterinary Pet Insurance Co., Brea, CA.

Contact Material

The kits herein may optionally provide contact material. The contact material is information regarding a contact that the user of the kit may communicate with regarding any questions regarding the pet, or regarding the contact that provided the kit to the user. In one embodiment, the contact material is information regarding a veterinarian, breeder, or pet food or pet medicinal supplier or manufacturer. In a preferred embodiment, the contact material is information regarding a veterinarian or breeder. Optionally, the contact material comprises one or more, or two or more of the following: name, address, telephone, e-mail address, or fax information. In one embodiment the contact material is in the form of a business card. Business cards are widely known in the art, and are typically flat or flexible cardstock or paper bearing information. Business cards may be of small size, such as less than about 20 centimeters in length and less than about 10 centimeters in width, more likely from about 6 centimeters to about 15 centimeters in length and from about 2 centimeters to about 8 centimeters in width.

### EXAMPLES

The following are non-limiting, optional, examples of the present kits, or various portions thereof (including optional portions). The following examples are provided to illustrate the invention and are not intended to limit the scope thereof in any manner.

### Example 1

The following are several examples of nutritional information:
1. When it comes to giving your new dog the best start on a happy and healthy life, nothing is more important than proper nutrition.
2. Inexpensive pet foods may appear to be a bargain until you realize that they don't provide the high premium-quality nutrition your new dog needs. Your dog will be happier and healthier with pet foods providing high quality ingredients for the complete and balanced nutrition your canine friend needs.
3. Here are some signs that your dog is benefiting from the nutrition of premium pet food:
   Exceptional muscle tone.
   A shiny, luxurious coat.
   Healthy bones and teeth.
   Clear, bright eyes.
   Small, firm stools.
   A happy, healthy, playful attitude.
4. The name of the pet food gives clues about how much of an ingredient is actually present.
5. The ingredient panel lists all food sources in the product in descending order by precooked weight. For dry food, you may want to make sure that the first ingredient is a source of high-quality protein, such as beef, chicken, or lamb.
6. The guaranteed analysis gives the percentage breakdown of the basic nutrients in the formula—protein, fiber and moisture content, for example.
7. When the nutritional adequacy statement states “animal feeding tests using AAFCO procedures,” this indicates that the food was actually fed to dogs and found to be adequate.
8. Information provided with pet food may provide how much food to feed your pet each day. Use these recommendations as a starting point to determine feeding amounts for your pet.
9. Unlike people, dogs are content eating a similar diet every day. Inappropriate feeding of human food can be harmful to dogs, such as chocolate, onions, bones, tomatoes, raw eggs, raw meat or poultry.

### Example 2

The following are several examples of pet care information:
1. Have these supplies available before your bring your dog or cat home with you: pet food, food and water bowls, identification tag, collar, travel crate, pet shampoo, brush or comb, or clean-up supplies such as paper towels.
2. Dog-proof your home. Keep household cleaners and chemicals out of your pet's reach. Restrict access to plant that are dangerous to pets. Store breakable items safely out of the way. Hide or cover electrical cords. Safely store antifreeze, engine oil, laundry detergents, and lawn chemicals. Use a cover or protective fencing if you have a pool or hot tub.
3. An appropriate amount of exercise will help promote your new pet's good behavior and assist you in training him. Talk with your veterinarian about how much daily exercise your breed typically needs. Some dogs are just naturally high-energy, and need more exercise than others.
4. You should have no trouble at all encouraging your children to play with your new dog. Still, you will want to supervise his first interaction with your kids and set playtime limits—15-20 minutes two or three times a day.
5. What to do if your pet is lost. First, don't panic. Look all over your property, including new places where your dog might try to hide. Search the neighborhood and talk to your neighbors. Help your pet find his way home—place his bedding or some of your dirty clothes outside your house as a homing scent. Call local veterinarians, shelters and humane societies. Post flyers in the area.

### Example 3

The following are several examples of insurance information:
1. He's part of the family now. Protect him with the best health insurance. Act now! Get the first 2 months' health insurance coverage paid for when you sign up for 12 months of health insurance coverage.
2. All for a low monthly premium, your puppy gets the following coverage:
   Routine care.
   Protection for major medical expenses.
   Choose any licensed veterinarian, anywhere.
3. Take advantage of all these benefits and receive annual reimbursements.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A kit comprising:
(a) a permanent filing container comprising a first outer panel, a second outer panel, and a receptacle formed at least in part by the outer panels; and
(b) two or more components contained within the kit, wherein the components are selected from the group consisting of pet food; a pet medicinal; incentive material; pet care material; nutritional material; health record; insurance material; and contact material; wherein the at least a portion of an outer panel is substantially transparent such that at least two of the components may be at least be partially viewed through the transparency formed therefrom.

2. The kit according to claim 1 comprising three or more of the components.

3. The kit according to claim 2 comprising pet food.

4. The kit according to claim 2 comprising a pet medicinal.

5. The kit according to claim 2 comprising incentive material.

6. The kit according to claim 2 comprising pet care material.

7. The kit according to claim 2 comprising nutritional material.

8. The kit according to claim 2 comprising a health record.

9. The kit according to claim 2 comprising insurance material.

10. The kit according to claim 2 wherein at least a portion of each of the first outer panel and the second outer panel is substantially transparent.

11. The kit according to claim 10 wherein the permanent filing container further comprises a connecting panel which permanently connects the outer panels.

12. The kit according to claim 11 wherein the permanent filing container is expandable.

13. The kit according to claim 12 wherein at least one of the outer panels comprises means for expanding the permanent filing container.

14. The kit according to claim 13 wherein the means for expanding the permanent filing container comprises a fold in the at least one of the outer panels.

15. The kit according to claim 13 wherein the means for expanding the permanent filing container comprises a plurality of pleats in the connecting panel.

16. The kit according to claim 12 further comprising means for further connecting the outer panels.

17. The kit according to claim 16 wherein the means for further connecting the outer panels comprises a flap which is permanently attached to the first outer panel.

18. The kit according to claim 17 wherein the flap is releasably attached to the second outer panel.

19. The kit according to claim 18 wherein the permanent filing container comprises a hook and loop system for releasably attaching the flap to the second outer panel.

20. The kit according to claim 12 comprising a second receptacle formed at least in part by a third outer surface which is at least in part substantially transparent and wherein the second receptacle is suitable to contain a business card therein.
